(19) United States
(12) Patent Application Publication
(10) Pub. No.: US 2025/0060953 A1
(43) Pub. Date: Feb. 20, 2025

(54) EVENT BUS MONITORING METHOD AND APPARATUS, AND DEVICE, AND MEDIUM

(71) Applicant: Beijing Bytedance Network Technology Co., Ltd., Beijing (CN)

(72) Inventors: Xinqi XIE, Beijing (CN); Meng HUANG, Beijing (CN)

(21) Appl. No.: 18/721,143

(22) PCT Filed: Dec. 13, 2022
(86) PCT No.: PCT/CN2022/138676

§ 371 Date: Jun. 17, 2024

(30) Foreign Application Priority Data
Dec. 17, 2021 (CN) 202111555478.7

(51) Int. Cl. G06F 8/41

(52) U.S. Cl. CPC G06F 8/443

(57) ABSTRACT

The present disclosure relates to an event bus monitoring method and apparatus, and a device, and a medium. The method includes: searching for a method conforming to a preset rule among all methods subordinate to a process file; searching for a first method conforming to the preset rule in each method subordinate to the process file; and on the basis of information of the first method, determining a target corresponding to the first method, and generating display information, wherein the target comprises a receiving target and a sending target, the information of the first method contains the type of the method and labeling information of the first method, and when the type of the found method is sending and when the information of the found method contains labeling information of the receiving target, it is determined that the found method conforms to the preset rule.

### CROSS-REFERENCE TO RELATED APPLICATIONS

This application is based on and claims the benefit of priority to the Chinese patent application No. 202111555478.7 with a title “AN EVENT BUS MONITORING METHOD, DEVICE, EQUIPMENT, AND MEDIUM”, filed on Dec. 17, 2021, which is hereby incorporated by reference in its entirety into the present application.

### TECHNICAL FIELD

The present disclosure relates to the field of computer technology, in particular to an event bus monitoring method, apparatus, device, and medium.

### BACKGROUND

Android is a free and open-source operating system based on the Linux kernel. The operating system is mainly used in mobile devices, such as smartphones and tablets.

In existing Android projects, EventBus serving as a solution to event bus is mainly used in data communication and also involves a cross-page communication scheme. As shown in FIG. 1, Typically, in the EventBus framework, there are two roles: an event receiver, namely a subscriber, and an event sender (publisher), who communicates through a post method.

### SUMMARY

The present disclosure provides an event bus monitoring method, device, equipment, and computer-readable storage medium for monitoring receivers' and senders' information, thereby improving code compilation efficiency.

In a first aspect, an embodiment of the present disclosure provides an event bus monitoring method, comprising: searching every method subordinate to a process file for
a first method that meets preset rules;
determining a target corresponding to the first method based on information of the first method, and generating display information;
wherein the target comprises a receiving target and a sending target, the information of the first method comprises one or more of a type of the first method or annotation information of the first method, and in response to the type of a method searched being send, or in response to the information of the method searched comprising annotation information of the receiving target, determining that the method searched meets the preset rules.

The event bus monitoring method provided in the embodiment of the present disclosure comprises: searching out the method that meets the preset rules, determining a target of the method based on the information of the method, and generating display information, so as to monitor the information of the target, thereby improving code compilation efficiency.

In one possible implementation in the method provided in the embodiment of the present disclosure, the determining a target corresponding to the first method based on information of the first method, and generating display information comprises:
in response to the type of the first method being send, determining that a caller of the first method is the sending target corresponding to the first method information, and generating the display information.

In one possible implementation in the method provided in the embodiment of the present disclosure, the determining a target corresponding to the first method based on information of the first method, and generating display information comprises:
in response to the information of the first method comprising annotation information of the receiving target, determining that a caller of the first method is the receiving target corresponding to the first method, and generating the display information.

In one possible implementation in the method provided in the embodiment of the present disclosure, in response to the type of the first method being send and the information of the first method comprising the annotation information of the receiving target, outputting the display information.

In one possible implementation in the method provided in the embodiment of the present disclosure, the searching every method subordinate to a process file for the first method that meets preset rules comprises:
in response to determining that the process file is in a preset whitelist, not searching any methods subordinate to the process file for the first method that meets the preset rules;
in response to the process file not being in a preset whitelist, searching every method subordinate to the process file for the first method that meets the preset rules.

The event bus monitoring method provided in the embodiment of the present disclosure adds a preset whitelist in order to skip the search in those process files in the whitelist, saving computation and improving search efficiency.

In one possible implementation in the method provided in the embodiment of the present disclosure, in response to registering a new target, searching all methods subordinate to the process file for a plurality of methods corresponding to the new target; and in response to the methods searched not comprising a method with the type of unregister, reporting an error; or
in response to the methods searched comprising a method with the type of unregister, registering the new target; or
in response to no method corresponding to the new target being searched, registering the new target.

The event bus monitoring method provided in the embodiment of the present disclosure reports an error if, in response to a new target being registered, the method corresponding to the new target is found and does not comprise a method with the type of unregister, so as to avoid a memory leakage problem caused by not unregistering and improve code compilation efficiency.

In one possible implementation in the method provided in the embodiment of the present disclosure, the searching for a plurality of methods that meet the preset rules within every method subordinate to the process file comprises:
in response to determining that the process file is in a preset whitelist, not searching all methods subordinate to the process file for the methods that meet the preset rules;
in response to the process file not being in the preset whitelist, searching every method subordinate to the process file for the methods that meet the preset rules.

The event bus monitoring method provided in the embodiment of the present disclosure adds a preset whitelist in order to skip the search in those process files in the whitelist, saving computation and improving search efficiency.

In a second aspect, an embodiment of the present disclosure provides an event bus monitoring apparatus, comprising:
a searching unit, for searching every method subordinate to a process file for a first method that meets preset rules;
a processing unit, for determining a target corresponding to the first method based on information of the first method and generating display information;
wherein the target comprises a receiving target and a sending target, the information of the first method comprises a type of the first method and/or annotation information of the first method, and in response to the type of a method searched is send, or in response to the information of the method searched comprising annotation information of the receiving target, determining that the method searched meets the preset rules.

In one possible implementation, the processing unit provided in the embodiment of the present disclosure is further configured to:
in response to the type of the first method being send, determining that a caller of the first method is the sending target corresponding to the first method information, and generating the display information.
provided in the embodiment of the present disclosure is further configured to: in response to the information of the first method comprising annotation information of a receiving target, determining that a caller of the first method is the receiving target corresponding to the first method, and generating the display information.

In one possible implementation, the processing unit provided in the embodiment of the present disclosure is further configured to:
in response to the type of the first method being send and the information of the first method comprising the annotation information of the receiving target, outputting the display information.

In one possible implementation, the processing unit provided in the embodiment of the present disclosure is further configured to: in response to determining that the process file is in a preset whitelist, not searching all methods subordinate to the process file for the first method that meets the preset rules;
in response to the process file not being in a preset whitelist, searching every method subordinate to the process file for the first method that meets the preset rules.
provided in the embodiment of the present disclosure is also configured to: in response to registering a new target, searching all methods subordinate to the process file for a plurality of methods corresponding to the new target; and in response to the methods searched not comprising a method with the type of unregister, reporting an error; or
in response to the methods searched comprising a method with the type of unregister, registering the new target; or
in response to no method corresponding to the new target being searched, registering the new target.

In one possible implementation, the processing unit provided in the embodiment of the present disclosure is further configured to: in response to determining that the process file is in a preset whitelist, not searching all methods subordinate to the process file for the methods that meet the preset rules;
in response to the process file not being in the preset whitelist, searching every method subordinate to the process file for the methods that meet the preset rules.

In a third aspect, an embodiment of the present disclosure provides an event bus monitoring equipment, comprising:
a memory;
a processor; and
a computer program;
wherein the computer program is stored in the memory and configured to be executed by the processor to implement the method as described in the first aspect.

In a fourth aspect, an embodiment of the present disclosure provides a computer-readable storage medium on which a computer program is stored, and the computer program is executed by the processor to implement the method of the first aspect.

In a fifth aspect, an embodiment of the present disclosure further provides a computer program product, which comprises a computer program or instruction, and the event bus monitoring method as described above is implemented in response to the computer program or instruction being executed by the processor.

In a sixth aspect, an embodiment of the present disclosure further provides a computer program, comprising: instructions that cause the processor to carry out the event bus monitoring method as described above in response to being executed by the processor.

### BRIEF DESCRIPTION OF THE DRAWINGS

The accompanying drawings herein are incorporated into the specification and form a part of this specification, illustrating embodiments in accordance with the present disclosure and explaining the principles of the present disclosure together with the description.

In order to provide a clearer explanation of the technical solutions in embodiments of the present disclosure or the related art, a brief introduction will be given below to the accompanying drawings required by the embodiments or the related art for descriptions. It is obvious for those skilled in the art that other drawings can be obtained based on these accompanying drawings without creative labor.

FIG. 1 is a flow chart of the EventBus method provided in the BACKGROUND of the present disclosure.

FIG. 2 is a flow schematic diagram of an event bus monitoring method provided in the embodiments of the present disclosure.

FIG. 3 is a flow schematic diagram of a receiver bus monitoring method provided in the embodiments of the present disclosure.

FIG. 4 is a flow schematic diagram of a sender bus monitoring method provided in the embodiments of the present disclosure.

FIG. 5 is a flow schematic diagram of a method for generating display information provided in the embodiments of the present disclosure.

FIG. 6 is a schematic diagram of a display information output provided in the embodiments of the present disclosure.

FIG. 7 is a schematic diagram of the structure of an event bus monitoring device provided in the embodiments of the present disclosure.

FIG. 8 is a schematic diagram of the structure of an electronic device provided in the embodiments of the present disclosure.

### DETAILED DESCRIPTION

In order to better understand the above objectives, features, and advantages of the present disclosure, the solution of the present disclosure will be further described below. It should be noted that, if without conflict, embodiments of the present disclosure and features in the embodiments can be combined with each other.

Many specific details are elaborated in the following descriptions to facilitate a full understanding of the present disclosure, but the present disclosure may be implemented in other ways different from those described herein; obviously, the embodiments in this description are only a part of the embodiments of the present disclosure, rather than the entire embodiments.

Here are explanations for some words that appear in the text.

In the embodiments of the present disclosure, the term “and/or” describes the association relationship of associated objects, indicating that there may be three types of relationships, such as A and/or B, which may indicate the presence of A alone, the presence of A and B simultaneously, and the presence of B alone. The character “/” generally indicates that the associated objects have an OR relationship.

Android: Android is a free and open-source operating system based on the Linux kernel, primarily used in mobile devices.

EventBus: a lightweight publish/subscribe framework for Android event that can replace traditional Intent, Handler, Broadcast, or interface functions in Android, to transport data between Fragment, Activity, and Service threads, and to execute methods.

In existing Android projects, the EventBus, being a solution to the event bus, is mainly used in data communication and also involves a cross-page communication scheme. Typically, in the EventBus framework, there are two roles: event receiver and event publisher. The receiver and the publisher (sender) are associated through events. After a Class subscribes to a certain type of event and another Class publishes (sends) the same type of event at a certain timing, all receivers of the event type can receive the message. However, it is not possible to directly obtain the message of all publishers and receivers of the EventBus, and the sources cannot be traced. In addition, during the use of the existing EventBus, if the EventBus is registered in a Class but not unregistered, a memory leakage may occur.

The relevant scheme lacks information about both event publishers and event receivers. For the same type of event, it is impossible to directly enumerate all receivers and all publishers of the event. At the same time, the relevant scheme cannot detect the error that the EventBus is not unregistered, which can lead to a memory leakage and even a system crash.

In response to this problem, embodiments of the present disclosure provides an event bus monitoring method. The method is elaborated below in conjunction with specific embodiments. In some embodiments, the event bus monitoring method is executed by an event bus monitoring apparatus or device.

As shown in FIG. 2, the embodiments of the present disclosure provide an event bus monitoring method, comprising the following steps:

S201, all methods subordinate to a process file is searched for a method that meets preset rules.

It should be noted that in response to the EventBus being used, IEvent interface is first realized on all events, that is, the original interface is replaced by the IEvent interface, and a target is annotated through the IEvent interface; and of course, the target can be annotated in other forms.

In a specific implementation, all methods subordinate to the process file is traversed to find all methods that meet preset rules; in response to a type of any method being send or information of the any method comprising an annotation of a receiving target, the any method is considered to meet the preset rules.

Before searching, a whitelist can also be preset. In response to a process file being in the preset whitelist, this process file is skipped and all methods subordinate to this process file are not searched, thereby saving system resources.

S202, a target corresponding to the method is determined based on the information of the method and display information is generated. The display information is used to at least display the determined target corresponding to the method.

It should be noted that the target comprises a receiving target and a sending target, which refer to a receiver and a sender taking part in EventBus communication. The information of the method comprises the type of the method and target annotation information of the method, wherein the target annotation information is annotated via the port accessed by a communication party.

(1) in response to the information of the method comprising the annotation information of the receiving target, it is determined that a caller of the method is the receiving target corresponding to the method, that is, the receiver, and the display information is generated.

In some embodiments, in response to a method being annotated with @Subscribe, it is determined that the information of the method comprises the annotation information of the receiving target, and then parameter information of the method is visited to obtain the specific type of the first parameter of the method. With the parameter's ClassName as the core, the ClassName and the MethodName of the current process are combined to form a new structure of data for storage. The stored structure can be a collection of Map structures or other easy-to-read structures. This is not limited in the embodiments of the present disclosure, and the Map structure will be used as an example for explanation.

(2) In response to the type of the method being send, it is determined that a caller of the method is the sending target corresponding to the method information, namely, the sender, and the display information is generated.

In some embodiments, in response to the method call in bytecode being of INVOKEVIRTUAL type and the method name being either “post” or “postSticky”, and the caller of this method being “IEvent”, it is determined that the caller of the method is the sending target corresponding to the method information. Then, using the caller's ClassName as the core, the ClassName and the MethodName of the current process are combined to form a new structure of data to be stored in the collection of Map structures.

In one possible implementation, implementation is performed before the bytecode instruction of post method to add additional information about the event sender, comprising but not limited to one or more of the following: current thread, event ID, class name of the sender or method name of the sender. Finally, a log output code is inserted to form a log text.

After the process compilation is completed, the Map data is embedded into a pre-written Hyper Text Markup Language (HTML) template to generate a HTML file that displays all event information in the project.

The embodiments of the present disclosure monitors the target information, and further improve the code compilation efficiency by searching out methods that meet the preset rules and determining the target of the method based on the information of the method, and generating the display information.

In addition, in response to registering a new target, all methods subordinate to the process file are searched for methods corresponding to the new target. In response to the methods searched not comprising a method with the type of unregister, an error is reported. In response to the methods searched comprising a method with the type of unregister or no method corresponding to the new target being searched, the new target is registered.

In a specific implementation, in response to the EventBus being registering a new target, first it is checked whether the current process hits a check whitelist. In response to the current process not hitting, every method call in the class is traversed and visited. In response to a certain method call in the bytecode being of type INVOKAVIRTUAL and the method name being “register”, and the method caller being the EventBus, the method is recorded to have an event register behavior and then all remaining methods in the process is continued to be traversed. In response to that the call in the bytecode is of type INVOKAVIRTUAL not being found, and the method name being “unregister”, and the method caller being an EventBus method, it indicates that the current process has an EventBus register behavior but does not have an unregister behavior, and thus an error information is output.

In the event bus monitoring method provided in the embodiments of the present disclosure, in response to registering a new target, if the method corresponding to the new target is found but it fails to comprise the unregister method, an error is reported to avoid memory leakage caused by not unregistering, thereby improving the code compilation efficiency.

Below are detailed explanations for the sender, the receiver, and the check of unregistering mentioned in the above embodiments.

As shown in FIG. 3, a flow schematic diagram of a receiver bus monitoring method provided in the embodiments of the present disclosure, comprises the following steps:
S301, every process file failing to hit the preset whitelist is searched.
S302, every method subordinate to the process file is scanned sequentially.

1S303, in response to the information of the every method comprising the annotation information of the receiving target, it is determined that the caller of the every method is the receiving target corresponding to the every method.

In some embodiments, in response to a method is annotated with @Subscribe, it is determined that the information of the method comprises the annotation information of the receiving target.

S304, the display information corresponding to the receiving target is generated.

In some embodiments, the specific type of the first parameter of the every method is obtained, and with the parameter's ClassName as the core, the ClassName and the MethodName of the current process are combined to form a new structure of data which is stored in the collection of the Map structures.

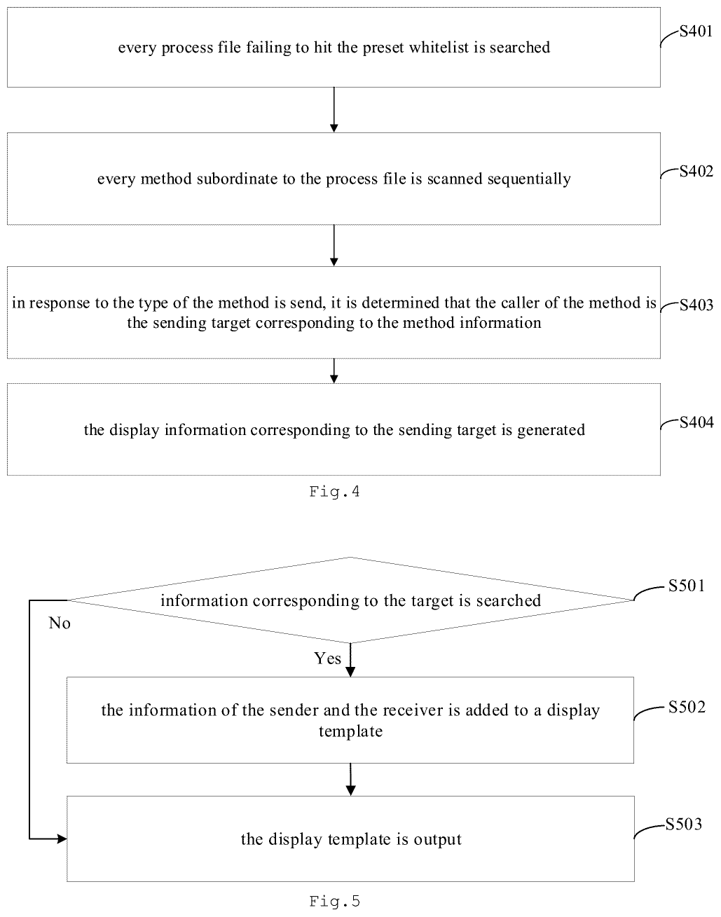

As shown in FIG. 4, a flow schematic diagram of a sender bus monitoring method provided in the embodiments of the present disclosure, comprises the following steps:
S401, every process file failing to hit the preset whitelist is searched.
S402, every method subordinate to the process file is scanned sequentially.
S403, in response to the type of the method is send, it is determined that the caller of the method is the sending target corresponding to the method information.

In some embodiments, in response to the method call in the bytecode being of type INVOKEVIRTUAL, the method name being either “post” or “postSticky”, and the caller of this method being IEvent, it is determined that the caller of the method is the sending target corresponding to the method information.

S404, the display information corresponding to the sending target is generated.

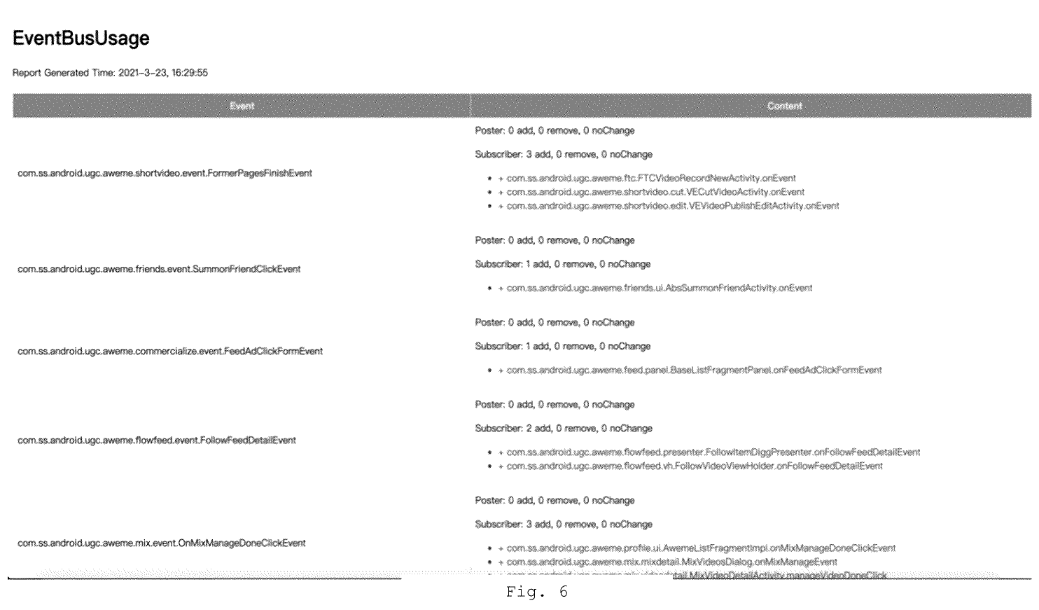

In some embodiments, with the ClassName of the caller as the core, the ClassName and the MethodName of the current process are combined to form a new structure of data, which is stored in the collection of the Map structures. Of course, instrumentation may also be performed before the bytecode instruction of the sending method to add additional information about the event sender, comprising but not limited to one or more of the following: current thread, event ID, class name of the sender or method name of the sender. Finally, a log output code is inserted to form a log text. As shown in FIG. 5, a flow schematic diagram of a method for generating display information provided in the embodiments of the present disclosure, comprises the following steps:
S501, information corresponding to the target is searched, in response to information of both sender and receiver existing simultaneously, S502 is executed, otherwise, S503 is executed.
S502, the information of the sender and the receiver is added to a display template.

In some embodiments, the display template uses an HTML template, into which the stored Map structure data is embedded.
S503, the display template is output. The display template is configured to display the display information determined in the aforementioned embodiments

In some embodiments, a display information output image shown in FIG. 6 is output.

As shown in FIG. 6, the “Event” column displays the events, and the “Content” column displays information of all

Subscribers and Posters of the events. For example, the information of the Subscribers and the Posters can be accurate to class and method. Taking the first row of events displayed in the “Event” column as an example, the information of the Poster comprises 0 add, 0 remove, and 0 noChange, while the information of the Subscriber comprises 3 add, 0 remove, and 0 noChange. The information of the Subscriber further displays three items of added contents in particular. The events in other rows are similar to the one in the first row and therefore will not be repeated here.

FIG. 7 shows an event bus monitoring apparatus provided in the embodiments of present disclosure, comprising:
a searching unit 701, for searching every method subordinate to a process file for a first method that meets preset rules;
a processing unit 702, for determining a target corresponding to the first method based on information of the first method and generating display information;

The target comprises a receiving target and a sending target, the information of the first method comprises a type of the first method and/or annotation information of the first method; in response to the type of the method searched being send, or in response to the information of the method searched comprises annotation information of a receiving target, it is determined that the method searched meets the preset rules.

In one possible implementation, the processing unit 702 provided in the embodiments of the present disclosure is further configured to:
in response to the type of the first method being send, determining that a caller of the first method is the sending target corresponding to the first method information, and generating display information.

In one possible implementation, the processing unit 702 provided in the embodiments of the present disclosure is further configured to: in response to the information of the first method comprising annotation information of a receiving target, determining that a caller of the first method is the receiving target corresponding to the first method, and generating the display information.

In one possible implementation, the processing unit 702 provided in the embodiments of the present disclosure is further configured to: outputting the display information in response to the type of the first method being send and the information of the first method comprising the annotation information of the receiving target.

In one possible implementation, the processing unit 702 provided in the embodiments of the present disclosure is further configured to: not searching all methods subordinate to a process file for the first method that meets the preset rules in response to determining that the process file is in a preset whitelist;
searching every method subordinate to the process file for the first method that meets the preset rules in response to the process file not being in a preset whitelist.

In one possible implementation, the processing unit 702 provided in the embodiments of the present disclosure is further configured to: searching all methods subordinate to a process file for a plurality of methods corresponding to a new target in response to registering the new target; in response to the methods searched not comprising a method with the type unregister, reporting an error; or
in response to the methods searched comprising a method with the type unregister, registering a new target; or.
in response to no method corresponding to the new target being searched, registering the new target.

In one possible implementation, the processing unit 702 provided in the embodiments of the present disclosure is further configured to: in response to determining that the process file is in a preset whitelist, not searching all methods subordinate to the process file for the methods that meets the preset rules;
in response to the process file not being in a preset whitelist, searching every method subordinate to the process file for the methods that meet the preset rules.

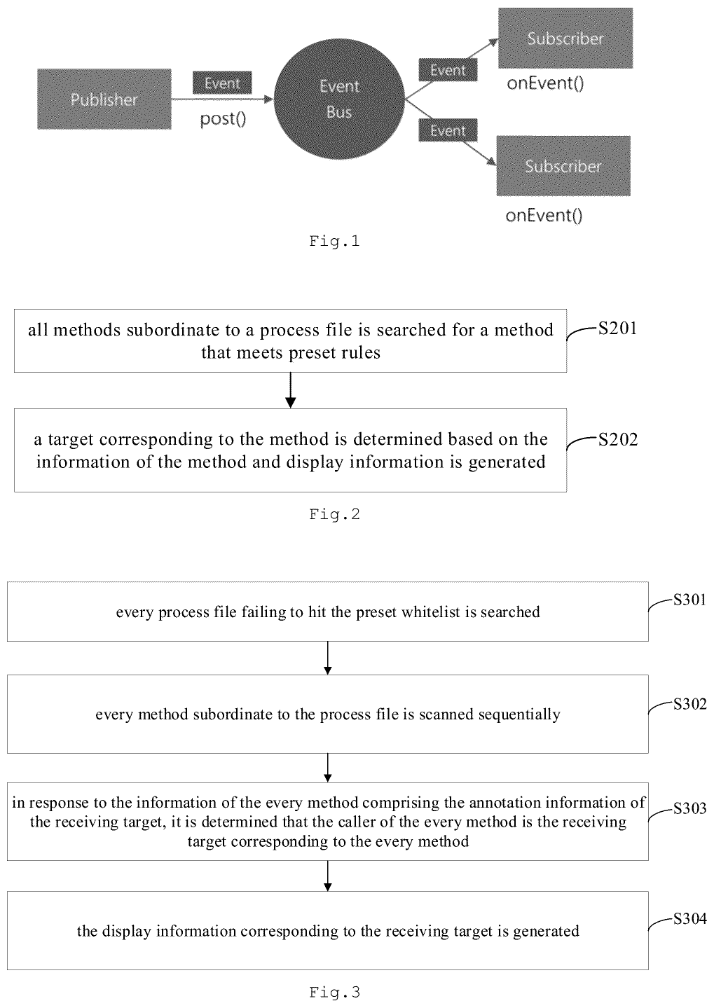

In addition, the event bus monitoring method and apparatus described in the embodiments of the present disclosure combined with FIGS. 1-7 can be realized by an electronic device.

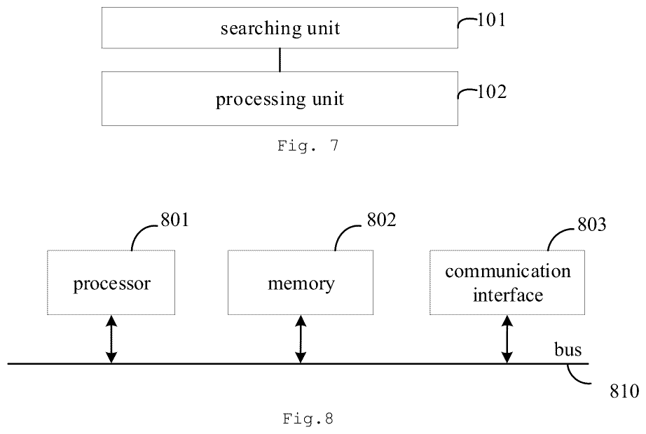

FIG. 8 shows a schematic diagram of the hardware structure of an electronic device provided in the embodiments of the present disclosure.

The electronic device may comprise a processor 801 and a memory 802 storing computer program instructions.

Specifically, the processor 801 may comprise a central processing unit (CPU), an Application Specific Integrated Circuit (ASIC), or may be configured to be one or more integrated circuits implementing the embodiments of the present disclosure.

The memory 802 may comprise a large capacity memory for data or instructions. To exemplify rather than limit, the memory 802 may comprise a Hard Disk Drive (HDD), a floppy disk drive, a flash memory, an optical disk, a magneto-optical disk, a magnetic tape, or a Universal Serial Bus (USB) drive, or a combination of two or more of them. In a suitable situation, the memory 802 may comprise a removable or non-removable (or fixed) medium. In a suitable situation, the memory 802 may be located inside or outside the data processing apparatus. In a specific embodiment, the memory 802 is a non-volatile solid-state memory. In a specific embodiment, the memory 802 comprise a Read-Only Memory (ROM). In a suitable situation, the ROM can be a Mask-Programmed ROM, a Programmable ROM (PROM), an Erasable PROM (EPROM), an Electrically Erasable PROM (EEPROM), an Electrically Alterable ROM (EAROM) or a flash memory, or a combination of two or more of them.

The processor 801 reads and executes computer program instructions stored in the memory 802 to implement any one of the determining methods for recommendation information as described in the above embodiments.

In some embodiments, the electronic device may also comprise a communication interface 803 and a bus 810. As shown in FIG. 8, the processor 801, the memory 802, and the communication interface 803 are connected and communicated with each other through the bus 810.

The communication interface 803 is mainly configured to achieve communication between various modules, devices, units, and/or equipment in the embodiments of the present disclosure.

The bus 810 which comprises hardware, software, or both, couples components of the electronic device together. To exemplify rather than limit, the bus may comprise an Accelerated Graphics Port (AGP) or other graphics bus, an Enhanced Industry Standard Architecture (EISA) Bus, a Front Side Bus (FSB), a Hyper Transport (HT) Interconnect, an Industry Standard Architecture (ISA) Bus, an Infinite Bandwidth Interconnect, a Low Pin Count (LPC) Bus, a Memory Bus, a Micro Channel Architecture (MCA) Bus, a Peripheral Component Interconnection (PCI) Bus, a PCI-Express (PCI-X) Bus, a Serial Advanced Technology Attachment (SATA) Bus, a Video Electronics Standards Association Local Bus (VLB), or other suitable bus, or a combination of two or more of them. In a suitable situation, the bus 810 may comprise one or more buses. Although the embodiments of the present disclosure describe and illustrate specific buses, the present disclosure may comprise any suitable bus or interconnect.

The electronic device can execute the event bus monitoring method in the embodiments of the present disclosure based on a received service request sent by a smart device, thereby realizing the event bus monitoring method and apparatus disclosed in this description combined with FIGS. 1-7.

In addition, in combination with the event bus monitoring method in the above embodiments, an embodiment of the present disclosure can provides a computer-readable storage medium to implement the event bus monitoring method. The computer-readable storage medium stores computer program instructions; the computer program instructions implement any of the event bus monitoring methods in the above embodiments in response to being executed by a processor.

In some embodiments, the present disclosure also provides a computer program, comprising: instructions that, in response to being executed by a processor, cause the processor to execute a method according to any embodiment of the present disclosure.

The event bus monitoring method, apparatus, device, and medium provided in the embodiments of the disclosure monitors the target information, and further improve the code compilation efficiency by searching out methods that meet the preset rules and determining the target of the method based on the information of the method, and generating the display information.

It should be noted that in this text, relational terms

such as “first” and “second” are only used to distinguish one entity or operation from another entity or operation, and do not necessarily require or imply any actual relationship or order between these entities or operations. Moreover, terms “comprise”, “include”, or any other variation thereof are intended to encompass non-exclusive inclusion, such that a process, method, item, or device that comprises a series of elements not only comprises those elements, but also comprises other elements that are not explicitly listed, or also comprises elements inherent to such process, method, item, or device. If without further limitations, the element defined by the statement “comprising one . . . ” do not exclude the existence of other identical elements in the process, method, item, or device that comprises the said element.

The above is only the specific implementation of the present disclosure, which enables those skilled in the art to understand or implement this disclosure. Various modifications to these embodiments will be obvious to those skilled in the art, and the general principles defined herein can be implemented in other embodiments without departing from the spirit or scope of the present disclosure. Therefore, the present disclosure will not be limited to the embodiments described herein, but will conform to the widest scope consistent with the principles and novel features disclosed herein.

1. An event bus monitoring method, comprising:
searching every method subordinate to a process file for a first method that meets preset rules;
determining a target corresponding to the first method based on information of the first method, and generating display information;
wherein the target comprises a receiving target and a sending target, the information of the first method comprises one or more of a type of the first method or annotation information of the first method, and in response to the type of a method searched being send, or in response to the information of the method searched comprising annotation information of the receiving target, determining that the method searched meets the preset rules.

2. The event bus monitoring method according to claim 1, wherein, the determining a target corresponding to the first method based on information of the first method, and generating display information comprises:
in response to the type of the first method being send, determining that a caller of the first method is the sending target corresponding to the first method information, and generating the display information.

3. The event bus monitoring method according to claim 1, wherein, the determining a target corresponding to the first method based on information of the first method, and generating display information comprises:
in response to the information of the first method comprising annotation information of the receiving target, determining that a caller of the first method is the receiving target corresponding to the first method, and generating the display information.

4. The event bus monitoring method according to claim 2, wherein the event bus monitoring method further comprises:
in response to the type of the first method being send and the information of the first method comprising the annotation information of the receiving target, outputting the display information.

5. The event bus monitoring method according to claim 1, wherein the searching every method subordinate to a process file for the first method that meets preset rules comprises:
in response to determining that the process file is in a preset whitelist, not searching any methods subordinate to the process file for the first method that meets the preset rules;
in response to the process file not being in a preset whitelist, searching every method subordinate to the process file for the first method that meets the preset rules.

6. The event bus monitoring method according to claim 1, wherein the event bus monitoring method further comprises:
in response to registering a new target, searching all methods subordinate to the process file for a plurality of methods corresponding to the new target; and
in response to the methods searched not comprising a method with the type of unregister, reporting an error; or
in response to the methods searched comprising a method with the type of unregister, registering the new target; or
in response to no method corresponding to the new target being searched, registering the new target.

7. The event bus monitoring method according to claim 6, wherein the searching for a plurality of methods that meet the preset rules within every method subordinate to the process file comprises:
in response to determining that the process file is in a preset whitelist, not searching all methods subordinate to the process file for the methods that meet the preset rules;
in response to the process file not being in the preset whitelist, searching every method subordinate to the process file for the methods that meet the preset rules.

8. An event bus monitoring apparatus, comprising:
a searching unit, for searching every method subordinate to a process file for a first method that meets preset rules;
a processing unit, for determining a target corresponding to the first method based on information of the first method and generating display information;
wherein the target comprises a receiving target and a sending target, the information of the first method comprises a type of the first method and/or annotation information of the first method, and in response to the type of a method searched is send, or in response to the information of the method searched comprising annotation information of the receiving target, determining that the method searched meets the preset rules.

9. The event bus monitoring apparatus according to claim 8, wherein the processing unit is specifically configured to:
in response to the type of the first method being send, determining that a caller of the first method is the sending target corresponding to the first method information, and generating the display information.

10. The event bus monitoring apparatus according to claim 8, wherein the processing unit is specifically configured to:
in response to the information of the first method comprising annotation information of a receiving target, determining that a caller of the first method is the receiving target corresponding to the first method, and generating the display information.

11. The event bus monitoring apparatus according to claim 9, wherein the processing unit is further configured to:
in response to the type of the first method being send and the information of the first method comprising the annotation information of the receiving target, outputting the display information.

12. The event bus monitoring apparatus according to claim 8, wherein, the processing unit is further configured to:
in response to determining that the process file is in a preset whitelist, not searching all methods subordinate to the process file for the first method that meets the preset rules;
in response to the process file not being in a preset whitelist, searching every method subordinate to the process file for the first method that meets the preset rules.

13. The event bus monitoring apparatus according to claim 12, wherein the processing unit is further configured to:
in response to registering a new target, searching all methods subordinate to the process file for a plurality of methods corresponding to the new target; and
in response to the methods searched not comprising a method with the type of unregister, reporting an error; or
in response to the methods searched comprising a method with the type of unregister, registering the new target; or
in response to no method corresponding to the new target being searched, registering the new target.

14. The event bus monitoring apparatus according to claim 13, wherein the processing unit is further configured to:
in response to determining that the process file is in a preset whitelist, not searching all methods subordinate to the process file for the methods that meet the preset rules;
in response to the process file not being in the preset whitelist, searching every method subordinate to the process file for the methods that meet the preset rules.

15. An event bus monitoring device, comprising:
a memory;
a processor; and
a computer program;
wherein the computer program is stored in the memory and configured to be executed by the processor to implement the method according to claim 1.

16. A non-transitory_computer-readable storage medium on which a computer program is stored, wherein the computer program is executed by the processor to implement the event bus monitoring method, comprising:
searching every method subordinate to a process file for a first method that meets preset rules;
determining a target corresponding to the first method based on information of the first method, and generating display information;
wherein the target comprises a receiving target and a sending target, the information of the first method comprises one or more of a type of the first method or annotation information of the first method, and in response to the type of a method searched being send, or in response to the information of the method searched comprising annotation information of the receiving target, determining that the method searched meets the preset rules.

17. (canceled)

18. The non-transitory computer-readable storage medium according to claim 16, wherein the determining a target corresponding to the first method based on information of the first method, and generating display information comprises:
in response to the type of the first method being send, determining that a caller of the first method is the sending target corresponding to the first method information, and generating the display information.

19. The non-transitory computer-readable storage medium according to claim 16, wherein the determining a target corresponding to the first method based on information of the first method, and generating display information comprises:
in response to the information of the first method comprising annotation information of the receiving target, determining that a caller of the first method is the receiving target corresponding to the first method, and generating the display information.

20. The non-transitory computer-readable storage medium according to claim 18, wherein the event bus monitoring method further comprises:
in response to the type of the first method being send and the information of the first method comprising the annotation information of the receiving target, outputting the display information.

21. The non-transitory computer-readable storage medium according to claim 16, wherein the searching every method subordinate to a process file for the first method that meets preset rules comprises:
in response to determining that the process file is in a preset whitelist, not searching any methods subordinate to the process file for the first method that meets the preset rules;
in response to the process file not being in a preset whitelist, searching every method subordinate to the process file for the first method that meets the preset rules.
